(19) United States
(12) Patent Application Publication
(10) Pub. No.: US 2014/0049034 A1
(43) Pub. Date: Feb. 20, 2014

(54) OPTICALLY VARIABLE SECURITY FEATURE

(71) Applicants: Roland Groetzner, Unterschleissheim (DE); Sebastian Baur, Moosburg (DE)

(72) Inventors: Roland Groetzner, Unterschleissheim (DE); Sebastian Baur, Moosburg (DE)

(73) Assignee: SCHREINER GROUP GMBH & CO. KG, Oberschleissheim (DE)

(21) Appl. No.: 14/009,578

(22) PCT Filed: Mar. 30, 2012
(86) PCT No.: PCT/EP2012/055855

§ 371 Date: Oct. 23, 2013

(30) Foreign Application Priority Data
Apr. 4, 2011 (DE) 10 2011 016 050.7

(51) Int. Cl. B42D 15/00; B41M 3/14

(52) U.S. Cl. CPC B42D 15/0073; B41M 3/14
USPC 283/85; 101/483

(57) ABSTRACT

The invention relates to an open optical security feature which provides for a high level of security and can be produced relatively straightforwardly in a technical production method. The security features of optically variable inks with tilt effect and the properties of a latent image are combined with one another and interwoven. By virtue of the security feature being generated by printing, the security feature can be realized in a cost-effective manner, but nevertheless with a very high level of security being provided. The resulting security feature can readily be verified at any time, by any desired individual, without any additional auxiliary means being required.

The present invention relates to a printed product having a security element as well as to a method for the production of such a printed product having a security element. The invention particularly relates to the production of a printed product having a counterfeit-proof optical element, which, if at all possible, cannot be copied by an alleged counterfeiter without the copy being evident.

Nowadays, an increased tendency has been found that high-quality and, in particular, expensive products are frequently copied. Aside from the economic damage that the manufacturer of the original products incurs as a result, there is the further difficulty that these copies generally are very frequently also of low quality. A buyer who acquires such a low-quality copy and is of the opinion that he has purchased an original product will be disappointed by the low quality of the product. However, since the buyer cannot immediately recognize that this is a copy and not the product of the original manufacturer, he will ascribe the poor quality to the original manufacturer. Therefore the original manufacturer incurs not only economic damage but also significant image damage.

If the copy is furthermore a product that is used in a safety-relevant sector, such as a replacement part for a motor vehicle brake or the like, for example, there is also a significant risk of death and injury for the purchaser of such a low-quality copy.

For this reason, the manufacturers of high-quality original products are very interested in enabling potential buyers to quickly and easily distinguish an original product from an alleged copy. Overt optical security features that can be rapidly checked without any additional aids, on the one hand, but on the other hand cannot be easily copied without the copy being evident, using the technical means available nowadays, are one possibility for this, for example.

Such an optical security feature is, for example, a hologram that is applied to a product or to the packaging of a product. However, such holograms are relatively expensive in production, on the one hand. On the other hand, it would also be possible that a certain amount of such holograms is made accessible to an alleged counterfeiter, who can then affix them to his copies.

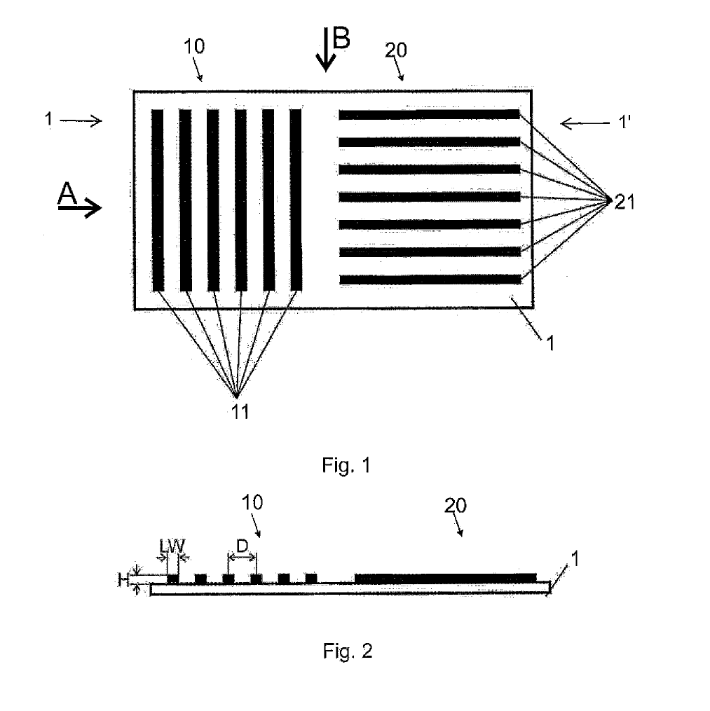

A further security feature that can be easily perceived optically is what is called a “latent image.” In this connection, this is understood to be a security feature applied by means of printing technology, which results in a different optical impression depending on the orientation of the viewing angle and the incident light. This is achieved in that in addition to the ink application, at the same time, a relief-like surface structure is produced by means of a printing method, preferably a recess printing method. In the relief, regions having a plurality of lines that run parallel are then formed, whereby fundamentally, there are two different types of regions, which differ in the orientation of the parallel lines. As shown in FIG. 1, the lines of one region run perpendicular to the lines of the other region. Depending on the orientation relative to the observer and the incident light, the one or the other region appears lighter, in each instance, in this connection. If one changes the orientation of this latent image, this effect reverses, and the region that originally appeared light then suddenly becomes the darker region. The difference in brightness results from the different shadows cast by the line structures that are oriented transverse to the incident light, in each instance.

These security features have become very well known and widespread in the meantime. This leads, among other things, to the result that alleged counterfeiters also have relatively easy access to the required know-how for the production of such security features. Thus, there is the risk that these security features, in and of themselves, can also already be imitated by alleged counterfeiters in the near future.

A further security feature to which counterfeiters will foreseeably not have access yet for a long time is the use of optically variable inks having a latent image effect. These are printing inks with special ink pigments that produce a different color impression depending on the observation angle. The variations of the perceived color impression is based, in this connection, predominantly on interferences that are brought about by the special pigments in the printing ink.

The production and sale of these color-effect pigments are subject to very strict restrictions. The pigments are therefore accessible only to selected printers, and thereby are not legally available to an alleged counterfeiter. Nevertheless, of course, it cannot be precluded that an alleged counterfeiter could also get into possession of a certain amount of such ink pigments.

It is therefore the task of the present invention to make available an overt security feature that can easily be perceived optically, at a very high security standard. In this connection, it should furthermore be possible to produce this security feature in as cost-advantageous and efficient a manner as possible.

This task is accomplished by a printed product having an optical security feature that comprises an imprinting material onto which a first line structure composed of a plurality of raised lines that run parallel to one another, which are applied to the imprinting material using a printing method. Furthermore, a second line structure composed of a plurality of raised lines that run parallel to one another is applied to the imprinting material. The second line structure is applied to the imprinting material using a printing method, and possesses an orientation that is different from the first line structure. In this connection, at least the printing ink for printing the first line structure contains ink pigments having a latent image effect.

The stated task is furthermore achieved by means of a method for the production of a printed product having an optical security feature, which first of all makes an imprinting material available. A first line structure composed of a plurality of raised lines that run parallel to one another is printed onto the imprinting material, whereby the printing ink for printing the first line structure contains ink pigments having a latent image effect. Furthermore, a second line structure composed of a plurality of raised lines that run parallel to one another is printed onto the imprinting material. The parallel lines of the second line structure possess an orientation that is different from the orientation of the parallel lines of the first line structure.

It is the particular approach of the present invention to combine two independent, overt security features to produce a joint security feature. In this connection, the security feature according to the invention is supposed to be able to be produced in a single work step. For this purpose, on the one hand, the “latent image” security feature is modified in such a manner that it can be produced, instead of using the conventional recess printing method, using an alternative printing method. Thus, a relief-like structure is not pressed into the imprinting material itself, but rather the required height differences are set onto the imprinting material by means of a printing ink applied in raised manner. At the same time, pigments having a latent image effect are mixed into the printing ink. In this way, two independent optical security features are firmly combined with one another.

By means of the interconnection of two security features that are independent, at first, a particularly strong, novel type of security feature is formed. This novel type of security feature is also an overt security feature, because it can be optically perceived and checked in simple manner, without additional aids. For this reason, it can be checked by almost everyone and at any desired point in time.

Preferably, the printing ink for printing the second line structure also contains ink pigments having a latent image effect. Thus, the security feature possesses an additional security aspect over the entire range of the latent image, by means of the latent image effect of the optically variable ink used.

In a particular embodiment, first a background imprinting is applied to the imprinting material, at first, at least over part of the area. Then, at least one of the first or the second line structure is printed onto this background imprinting. Preferably, both line structures, the first and the second line structure, are printed onto the background imprinting. In this way, for one thing, the contrast and thereby the latent image effect of the latent image can be clearly increased. Furthermore, the background imprinting allows refinement of the surface of the imprinting material, so that the line structures can be imprinted with a clearly better quality. In this connection, matte, dark colors such as black, for example, are particularly advantageous.

Preferably, the first and the second line structure have a height of at least 10 micrometers. In this connection, the latent image effect of the latent image becomes all the better evident, the higher the imprinted lines of the first and the second line structure are.

In a preferred embodiment, the printing varnish for the first and the second line structure is hardened after printing. In this connection, hardening by means of thermal, ultraviolet or infrared radiation has proven to be particularly advantageous.

In a very special embodiment, the printed product comprises at least a third line structure composed of a plurality of raised lines that run parallel to one another, which are applied to the imprinting material using a printing method. In this connection, the third line structure possesses an orientation that is different from the first and the second line structure.

Preferably, the printing ink for printing the first line structure contains at least 30 weight-percent ink pigments having a latent image effect. In this way, a high quality of the impression of the optically variable inks can be guaranteed for the security feature according to the invention.

Preferably, the raised lines of the first line structure have at least a width of at least 130 micrometers. The ratio of line distance to line width of the raised lines of the first line structure preferably amounts to at least 1.5. With these parameters, an excellent effect of the security features used can be achieved, on the one hand. On the other hand, these parameters also allow reliable production technology settings for the production of the security features, using a printing method.

In the following, the structure of a security feature according to the invention will be described using the figures. These show:

FIG. 1: a schematic representation of a security feature according to the invention in a top view;

FIG. 2: a schematic representation of a security feature according to the invention in cross-section;

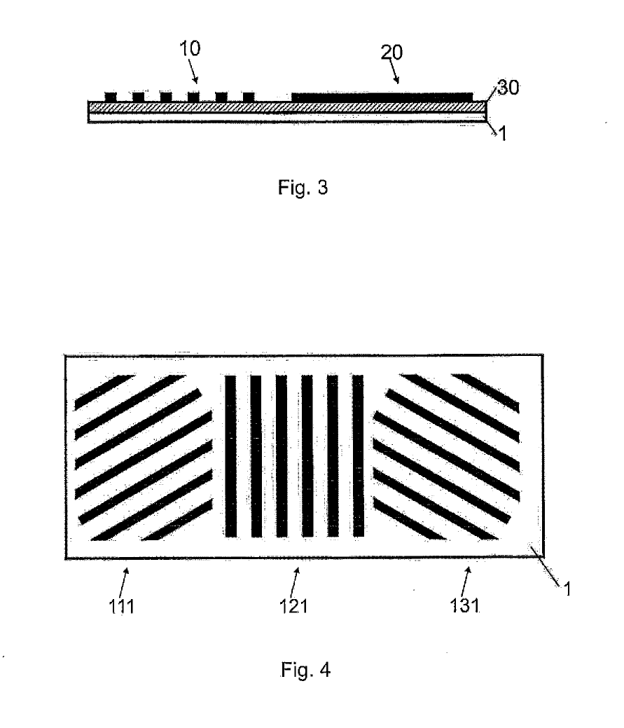

FIG. 3: a schematic representation of an alternative exemplary embodiment of a security feature according to the invention in a top view;

FIG. 4: a schematic representation of a further alternative exemplary embodiment of a security feature according to the invention in a top view;

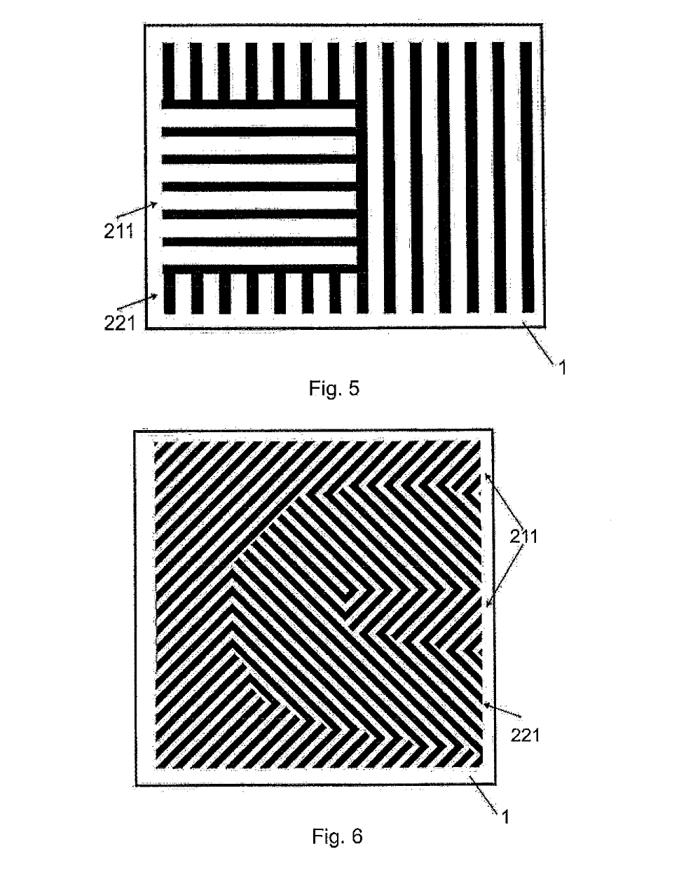

FIG. 5: a schematic top view of an alternative embodiment, with line groups that touch one another and engage into one another; and

FIG. 6: a schematic top view of a further alternative embodiment, with line groups that touch one another and engage into one another.

In this connection, the figures show the structure according to the invention only schematically. For a better illustration, the actual size ratios are not taken into consideration at all. The schematic representations of the figures do not represent any restrictions of the structure according to the invention.

FIG. 1 schematically shows the fundamental structure of the “latent image” security feature, as it is implemented in the method according to the invention. What is shown is a label provided with a security feature. In the left region 10, multiple raised lines 11 are applied to an imprinting material 1. The lines 11 run horizontally in this region. In the region 20, next to the former to the right, multiple raised lines 21 are also applied. These lines 21 run vertically. Thus, the orientation of the line 11 is offset by 90° relative to the orientation of the lines 21.

FIG. 2 schematically shows a section along the line 1-1′ through such a structure shown in FIG. 1. In this connection, the raised structure of the lines can be clearly recognized.

If such a structure is now illuminated by a light source from the direction A in FIG. 1, the raised lines 11 cast a clear shadow in the left region 10, into the interstices between the individual lines 11 the interstices therefore appear to be rather dark. In the right region 20, on the other hand, the interstices between the lines 21 are well illuminated by the light source and therefore appear to be lighter.

If, on the other hand, the structure is illuminated by a light source from the direction B, then the interstices between the lines 11 appear to be rather light, while the interstices between the lines 21 appear to be rather dark. The optical impression in the regions 10 and 20 therefore varies according to the light incidence and the viewing direction.

In order to produce a structure for such a security feature, without directly changing the surface of the imprinting material 1 in this connection, as would be the case in conventional production of a latent image using the recess printing method, the raised line structures 11 and 21 are imprinted onto the imprinted material 1 in raised manner, using the method according to the invention. Fundamentally, all printing methods that can apply a corresponding printing ink to the imprinting material 1 in the required thickness are suitable for this purpose. Here, application using screen printing, for example, has proven to be particularly advantageous.

The lines 11 of the region 10 are applied to the printing material 1 using a first printing method, for example. The lines 21 of the region 20 are then subsequently applied to the printing material 1 using a further, second printing method. The printing methods differ, for example, in the orientation of the measures with which the raised structures are produced.

In order to obtain a well perceivable optical change when the light incidence and viewing angle are varied, line heights of preferably at least 5 to 10 μm or better at least 30 μm have proven themselves. Line heights of up to 100 μm would be desirable, but can only be implemented with difficulty using the methods technically available nowadays.

In practical series of experiments, it was possible to achieve very good results with regard to the perceptibility of the security features using line heights of approximately 26 micrometers.

Fundamentally, all inks with which a desired line height can be achieved can be used as printing inks for the production of such raised line structures 11 and 21. Usually, the printing ink for the raised lines 11 and 21 is liquid or at least of a viscous consistency during the process. In order to transform the printing ink to a solid state as quickly as possible after printing, the printed lines 11 and 21 should harden as quickly as possible. For this purposes, methods in which a corresponding printing ink is activated after printing are particularly suitable, so that chemical or physical hardening is initiated. For example, the printing ink can be irradiated, after printing, with microwave radiation, for example infrared or ultraviolet light, and thereby hardening can take place. Because no substances are generally given off into the environment during this process, the volume of the imprinted lines also does not change, and this has an advantageous effect on the desired height of the lines, which is as great as possible.

Printing inks containing a solvent that evaporates into the surroundings after printing can fundamentally also be used. However, in this connection it should be taken into consideration that the volume of the lines and therefore also the line height is reduced as the result of evaporation of the solvent. Therefore the impression of the optical variation when tilting the latent image of the security feature is also slightly reduced.

In order to increase the security effect of a latent image produced in this manner, ink pigments having what is called a latent image effect (optically variable ink pigments) are additionally mixed into the printing ink for production of the raised lines 11 and 21 for a security feature according to the invention.

These ink pigments having a latent image effect, which are for the production of what are called optically variable inks, involve tiny, multi-layer small plates. If light impacts on such a small plate, the light is partly reflected at the individual layers, and partly transmitted. In interplay with the individual light components which are therefore reflected at different layers of a small plate, interferences occur in this way, which can lead to variable color impressions, depending on the viewing angle. Depending on the structure of the individual small plates, the changing color impression varies, in this connection.

By means of mixing such ink pigments having a latent image effect into the printing ink for building up the lines for the latent image, a combination of two safety features which are separate, at first, is generated. In this connection, it is particularly advantageous that the printing ink for the lines of the latent image can be printed just like before, without additional work steps being required in the printing process. This is of significant advantage, particularly with regard to the time for preparation for printing and the production costs.

In this connection, mixing a proportion of at least 30 weight-percent of optically variable ink pigments into the printing ink has proven to be particularly suitable. Specifically in the case of low line heights, the impression of color variation can otherwise be significantly impaired.

In this connection, the quality of the security feature already increases if only a part of the raised lines contain the ink pigments having the latent image effect. For example, it is possible that only the lines 11 of a region 10 are provided with such ink pigments, and the lines 21 of another region 20 are printed with an ink without such special optically variable ink pigments. Of course, it is also possible that all the raised lines 11 and 21 are produced using a printing ink that contains the corresponding ink pigments.

In this connection, the relatively great height of the raised lines 11 and 21 for the structure of the latent image specifically proves to be particularly advantageous also for the effect of the optically variable inks. The effect of the optically variable inks also appears all the stronger, the higher the ink is applied.

In this connection, the distance D between the individual lines 11 or 21, relative to one another, and also the width LW of the individual lines depend on the nature of the image to be represented. Because of the different demands that result from the constraints of the two security features latent image and optically variable ink, as well as the general conditions for printing the raised structures, conditions that might oppose one another, in part, must be taken into consideration. The distance D between the lines is, for example, the distance between two repeating structures of the lines that correspond to one another, for example the distance between the line centers of two directly adjacent lines.

Thus, for example, small line widths are advantageous for as clear a latent image as possible, while larger line widths tend to be aimed at for reproduction using printing technology.

For generation of a security feature according to the invention, composed of latent image and optically variable ink, it has proven to be particularly suitable, in this connection for production using printing technology, to select a line width LW of at least 130 μm. The ratio of line distance D to line width LW should preferably not go below a value of at least 1.5. As a result, the distance D should amount to at least 195 μm at the minimal line width LW to be aimed at, of 130 μm. In this connection, the actual specifications of the structure can vary, depending on the size and the content of the security feature.

Almost any imprintable material is suitable as an imprinting material onto which the raised lines 11 and 21 described above are imprinted. In this connection, it is particularly advantageous if the material for the imprinting material 1 has as smooth a surface as possible. The imprinting material 1 should furthermore absorb as little of the printing ink as possible, so that in the best case, the entire volume of the printing ink applied is available on the surface of the imprinting material 1 for the raised line structures 11 and 21. A highly absorbent imprinting material would absorb a significant portion of the imprinted ink, thereby causing less ink substance to be available for formation of the raised line structures of the latent image.

For this reason, plastic films of all kinds, such as those produced from polyethylene or polyvinyl chloride, are very well suited as imprinting materials or as substrates to be imprinted or as imprinting substrates. However, other plastic films that possess the properties described above are also suitable for being imprinted with the security feature according to the invention. Furthermore, papers, particularly papers having a coated surface, are also excellently suitable.

To increase the latent image effect of the latent image before imprinting of the raised line structures 11 and 21, the surface of the imprinting material 1 can still be coated with a background imprinting 30. A corresponding structure with background imprinting 30 is shown in FIG. 3. Preferably, a relatively dark color, for example a dark blue or red, is selected for the background imprinting. Background imprinting with black ink has also proven to be particularly advantageous. Preferably, the background imprinting 30 has a matte or semi-gloss nature.

At the same time, the surface of the imprinting material 1 can also be refined by means of coating of the imprinting material 1 with a background imprinting 30. In other words, even surfaces that are relatively rough, at first, can be given a smooth surface by means of the coating, and therefore imprinting of the raised lines 11 and 21 is very well possible. Furthermore, by means of application of a surface imprinting, the absorbent effect of the imprinting material can also be reduced, and this has a positive effect on the expected line height of the imprinted lines.

In the preceding exemplary embodiments, the raised lines 11 and 21 have an orientation perpendicular to one another, i.e. they run at least approximately at a 90° angle relative to one another. Beyond this, the effect of a latent image, possibly with a slightly weakened effect, can also be achieved with lines that run at an angle different from 90° relative to one another. For example, lines would also be possible that run at an angle of about 60° or 45° relative to one another.

The structure of a latent image presented until now, composed of two line groups, does not represent any restriction in this connection. FIG. 4 shows a further exemplary embodiment in which the latent image is composed of three raised line groups 111, 121, and 131. Latent images with the three line groups shown here, or even more, are fundamentally possible, in this connection. In this way, far greater variability of the latent image effect is achieved, and a higher security level of the security feature according to the invention is achieved.

The line group 111 has an orientation composed of parallel raised lines, in which all the lines have an acute angle relative to a reference line, for example a line oriented horizontally. The angle is 45°, for example. The line group 121 has a number of parallel raised lines that run perpendicular to the reference line. The line group 131 has a number of raised lines that run parallel to one another, which have an obtuse angle relative to the said reference line, for example 135°.

In this connection, either all the line groups 11, 21, and 31 or 111, 121, 131 can be produced from printing inks having optically variable pigments, or only one or two of the line groups are provided with such pigments. Here, too, the security level of the security feature produced in this manner can be significantly increased by means of the use of the optically variable ink pigments having a latent image effect.

In the preceding figures, the regions of the individual line groups 11, 21, and, if applicable, 31 are shown separate from one another. In practice, however, the different line groups engage into one another, overlap or touch. By means of the interconnection of the line structures, information in the form of a symbol, a number, a logo or the like can be formed, in this connection. Two embodiment variants used as examples are shown in FIGS. 5 and 6 for this purpose, in which the line groups 211 and 221 engage into one another, in each instance. In this connection, FIG. 5 illustrates the fundamental principle, while FIG. 6 represents a detail from a security feature that has practical relevance. Other embodiments of line structures that engage into one another are also possible, of course.

In FIG. 5, the line group 211 is completely surrounded, on three of its sides, namely, with regard to the plane of the drawing, from above, from the right, and from below, by the line group 221. Only the edge of the line group 221 shown on the left is free and not surrounded by the line group 211. Embodiments are also possible in which the line group 211 (not shown) is completely surrounded by lines of the line group 221, all around, from all sides. With regard to the orientation of the lines of the first line group 211 relative to the lines of the second line group 212 in FIG. 5, it can be stated that the lines of the one group run perpendicular to the lines of the second group, with regard to their orientation.

In FIG. 6, the lines of the line group 221 run along a strip-shaped progression within the lines of the line group 211. For example, the strip for the lines of the line group 221 starts at the top right, then runs to the left, is guided in an arc that points to the right, so that the orientation practically reverses and the strip once again runs to the right at the edge of the latent image. Within the strip, the lines of the line group 221 are disposed parallel to one another.

In summary, the present invention relates to an overt optical security feature having a high security standard, which can be produced relatively easily, using a technical production method. In this connection, the security features of optically variable inks having a latent image effect and the properties of a latent image are combined and interconnected with one another. By means of the production of the security feature using a printing method, the security feature can be implemented in cost-advantageous manner, but nevertheless at a very high security standard. The security feature produced in this manner can be verified by anyone, at any time, in simple manner, without additional aids.

1. Printed product having an optical security feature, comprising:
an imprinting material;
a first line structure composed of a plurality of raised lines that run parallel to one another, which are applied to the imprinting material using a printing method; and
a second line structure composed of a plurality of raised lines that run parallel to one another, which are applied to the imprinting material using a screen printing method, and possesses an orientation that is different from the first line structure;
wherein the printing ink for printing the first line structure contains ink pigments having a latent image effect.

2. Printed product according to claim 1, wherein the printing ink for printing the second line structure contains ink pigments having a latent image effect.

3. Printed product according to claim 1, which furthermore has a background imprinting on the imprinting material, at least over part of the surface, wherein at least one of the first or the second line structure is imprinted onto the background imprinting.

4. Printed product according to claim 3, wherein the background imprinting is carried out with a darker, preferably black ink.

5. Printed product according to claim 1, wherein the first and the second line structure have a height of at least 5 micrometers, preferably at least 10 micrometers.

6. Printed product according to claim 1, wherein the first and the second line structure are applied with a printing varnish, and the printing varnish is hardened by means of irradiation.

7. Printed product according to claim 1, which furthermore has at least a third line structure composed of a plurality of raised lines that run parallel to one another, which are applied to the imprinting material using a printing method, wherein the third line structure possesses an orientation different from the first and the second line structure.

8. Printed product according to claim 1, wherein printing ink for printing of the first line structure contains at least 30 weight-percent ink pigments having a latent image effect.

9. Printed product according to claim 1, wherein raised lines of the first line structure have a width of at least 130 micrometers.

10. Printed product according to claim 1, wherein the ratio of line distance to line width of the raised lines of the first line structure amounts to at least 1.5.

11. Method for the production of a printed product having an optical security feature, which comprises the following steps:
making available an imprinting material;
screen printing a first line structure composed of a plurality of raised lines that run parallel to one another, wherein the printing ink for printing of the first line structure contains ink pigments having a latent image effect;
printing of a second line structure composed of a plurality of raised lines that run parallel to one another.

12. Method according to claim 11, wherein the printing ink for printing the second line structure contains ink pigments having a latent image effect.

13. Method according to claim 11, which furthermore has a step for applying a background imprinting on the imprinting material, at least over part of the surface, and wherein at least one of the first or the second line structure is imprinted onto the background imprinting.

14. Method according to claim 13, wherein the step for applying the background imprinting is carried out with a darker, preferably black ink.

15. Method according to claim 11, wherein the steps for printing the first and the second line structure imprint lines, in each instance, having a height of at least 10 micrometers.

16. Method according to claim 11, which furthermore comprises a step for hardening of the printing varnish of the first and the second line structure.

17. Method according to claim 11, which furthermore comprises a step for printing of a third line structure composed of a plurality of raised lines that run parallel to one another, wherein the third line structure possesses an orientation different from the first and the second line structure.
